(19) United States
(12) Patent Application Publication
(10) Pub. No.: US 2007/0248772 A1
(43) Pub. Date: Oct. 25, 2007

(54) Inlaying process for installing features in a synthetic sports field

(76) Inventor: Charles Cook, Rochester, MI (US)

Correspondence Address: Dickinson Wright PLLC, 38525 Woodward Avenue, Suite 2000, Bloomfield Hills, MI, 48304, US

(21) Appl. No.: 11/410,557

(22) Filed: Apr. 25, 2006

(51) Int. Cl. A41G 1/00; B32B 3/00

(52) U.S. Cl. 428/17; 428/58; 156/93

(57) ABSTRACT

A process for inlaying features into a synthetic turf field is disclosed in which a portion of the field is first removed down to the substrate, leaving an opening. A layer of seam tape is introduced to the underlying substrate within the opening. An adhesive is applied to the top surface of the seam tape. A new section of the synthetic grass material, having the features as desired, is then laid onto the adhesive within the opening. A roller is introduced over the new section of turf one or more times to cause a portion of the adhesive material to infiltrate the pores along the bottom of the backing material prior to complete cure of the adhesive material. The four corners of the new section of synthetic turf are stitched to the previously placed turf to ensure that the corners don't peel upwardly during play.

### TECHNICAL FIELD AND INDUSTRIAL APPLICABILITY OF THE INVENTION

The present invention relates generally to synthetic sports fields and more specifically to an inlaying process for installing features in a synthetic sports field.

### BACKGROUND OF THE INVENTION

Synthetic grass sports surfaces are well known. These surfaces are becoming increasingly popular as replacements for natural grass surfaces in stadiums, playgrounds, golf driving ranges, and a variety of other facilities. The synthetic grass surfaces stand up to wear much better than the natural grass surfaces, do not require as much maintenance, and can be used in partially or fully enclosed stadiums where natural grass cannot typically be grown.

Most synthetic grass surfaces comprise rows of strips or ribbons of synthetic grass-like material, extending vertically from a backing mat with particulate material infill in between the ribbons on the mat. One or more layers of aggregate material are introduced between the backing mat and on top of a smoothed and compacted subgrade. The surfaces are preferably crowned to promote water drainage.

The ribbons of synthetic grass-like material usually extend a short distance above the layer of particulate material and represent blades of grass. The length of these fibers is dictated by the end use of the playing surface. For example, football fields utilize fibers that are longer than golf driving range surfaces. The particulate material usually comprises sand, as shown by way of example in U.S. Pat. No. 3,995,079 and U.S. Pat. No. 4,389,435, both to Haas, Jr. More recently, the particulate matter can also comprise a mixture of sand and other materials, including rubber infill, as shown, for example, in U.S. Pat. No. 6,338,885 to Prevost, or entire rubber infill systems, such as those disclosed in U.S. Pat. No. 5,976,645 to Daluise et al. In these systems, the particulate matter provides resiliency to the synthetic grass surfaces and adds weight to hold down the backing material, thus helping to ensure that the strips of synthetic grass do not move or shift during play.

The synthetic turf playing surface typically includes one or more features that are added to the field to provide an aesthetically pleasing look or alternatively to define a functional aspect of the field such as a boundary line or other marking. Examples of such features include numbers, letters, logos, yard lines, and sideline markings. While it is theoretically possible to form synthetic turf fields wherein these associated features are tufted directly into the field during the manufacturing process, the more preferred process for introducing these features today is typically accomplished in a post-manufacturing and installation step via an inlaying or stenciling process. One representative example of the inlaying and stenciling process are described, for example, in U.S. Publication No. 2005/0129906 A1 to Knox.

In the inlaying process as shown in Knox, a template is introduced onto one or more strips of the previously placed field at a position determined by laser plotting or some other kind of alignment technique. A cutting utensil is used to cut through the backing layers corresponding to the edges of the stencil. The cut out portion of the strip or strips is removed, leaving an opening. The edges of the strip or strips around the opening are rolled back, and a layer of seam tape is introduced to the underlying surface (here an aggregate layer). An adhesive is then applied to the top surface of the seam tape, and the edges of the strip or strips are rolled back down to partially cover some of the seam. A new section of the synthetic grass material, having the features as desired, corresponding in size to the cut out portion is then laid onto the adhesive within the opening.

Synthetic turf fields having inlayed features have experienced problems associated with the inlaid features. Most specifically, the corners of the inlaid strip have a tendency to pull up away from the adhesive, a condition that is both undesirable from an aesthetic standpoint and is a potential source of concern in terms of injury and performance to a player participating on the field. Further, the inlaying process does not take into account the expansion and/or contraction of the field associated with weather conditions, including specifically changes in temperature from warm to cold. These weather conditions may cause the inlayed strip or surrounding strips to bulge outward and effect the overall playing characteristics of the field.

It is thus highly desirable to produce a synthetic grass surface having improved durability of the inlaid features, particularly along the corners of the inlaid strip. It is also highly desirable that the inlaid strips take into account different weather conditions.

### SUMMARY OF THE INVENTION

The present invention is directed to a new and improved process for inlaying features into a synthetic grass surface.

The new process for inlaying the features begins by first introducing a template onto one or more strips of the previously placed field at a position determined by laser plotting or some other kind of alignment technique. A cutting utensil is used to cut through the backing layers corresponding to the edges of the stencil along three sides of the backing layer. The portion of the field is then rolled upward, wherein the fourth side is cut using the cutting utensil from the back side of the backing material. The cut out portion of the strip or strips is removed, leaving an opening. A layer of seam tape is introduced to the underlying substrate within the opening. An adhesive is applied to the top surface of the seam tape. A new section of the synthetic grass material, having the features as desired, corresponding in size to the cut out portion is then laid onto the adhesive within the opening. The new section of turf is introduced such that the grain of the turf, and the rows of tufting, substantially match the grain and tufting of the previously placed turf. The new section of turf is sized slightly smaller than the size of the opening, therein forming a gap between it and the previously placed turf along its outer periphery. This gap allows the field to contract or expand in ever changing weather conditions without bulging or causing deformities in the synthetic turf surface.

A roller is introduced over the new section of turf to cause a portion of the adhesive material to infiltrate the pores along the bottom of the backing material prior to complete cure of the adhesive material. The process is preferably repeated after approximately four hours to ensure that the seam tape is bound to the backing material. Finally, each of the four corners of the new section of synthetic turf is stitched to the previously placed turf using thread or some other type of material to ensure that the corners don't peel upwardly during play. In alternative arrangements, the corners may be stitched prior to introducing the rollers to the inlayed strip.

Other objects and advantages of the present invention will become apparent upon considering the following detailed description and appended claims, and upon reference to the accompanying drawings.

### BRIEF DESCRIPTION OF THE DRAWINGS

FIG. 1 is a top perspective view of a portion of a sports field according to one preferred embodiment of the present invention;

FIG. 2 is a perspective view of a portion of a synthetic grass strip of FIG. 1;

FIG. 3 is a section view of a portion of FIG. 2 taken along line 3-3;

FIG. 4 is a perspective view of a method for cutting three sides of a section of the sports field within a template associated with the inlaying of a feature as shown in FIG. 1;

FIG. 5 is a perspective view of a method for cutting a fourth side of the section of the sports field of FIG. 4 and removing the cut section of the sports field associated with the inlaying of a feature as shown in FIG. 1;

FIG. 6 is a perspective view of the method for preparing the opening formed in accordance with FIGS. 4 and 5 for the subsequent introduction of an inlayed section of turf as shown in FIG. 1;

FIG. 7 is a perspective view of the method for introducing and securing the inlayed section of turf within the opening of FIG. 6; and

FIG. 8 is a section view of a portion of FIG. 7 taken along line 8-8.

### DETAILED DESCRIPTION AND PREFERRED EMBODIMENTS OF THE INVENTION

The present invention describes a synthetic turf sports playing surface 20, here a football field, according to one preferred embodiment of the present invention. The surface 20 has one or more strips 22 of a synthetic turf grass surface 24 placed lengthwise from one widthwise end 42 to the other widthwise end 43 on either side of a central strip 122. The strips 22, 122 are placed onto a firm and substantially level substrate 64. An optional shock resistant layer 63 may be introduced between the substrate 64 and the respective strips 122, 22, to provide additional bounce-back to the playing surface 20 during use.

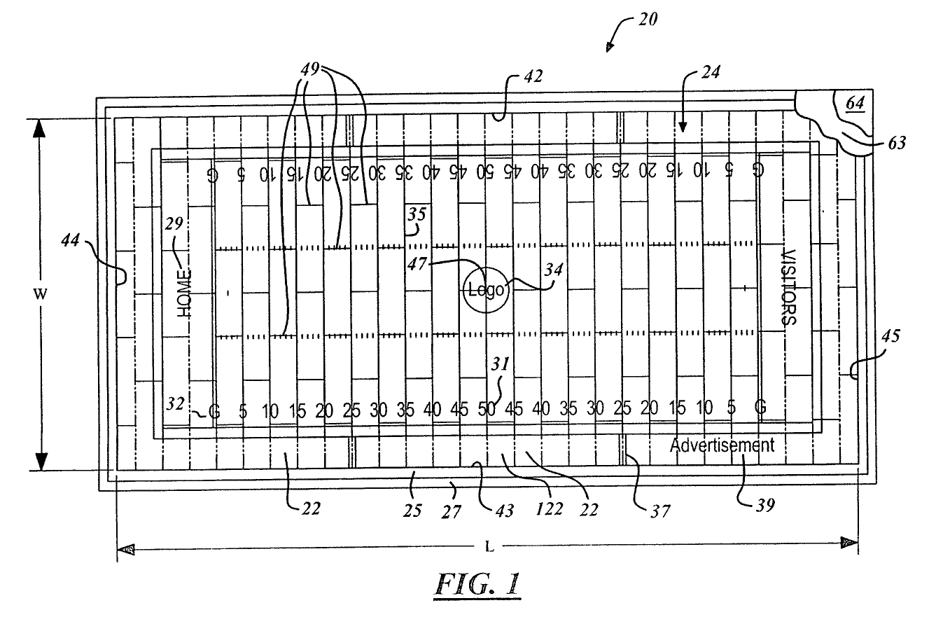

The number of strips 22 is determined by the overall length L of the field 20 extending a first lengthwise end 44 to a second lengthwise end 45 (shown as the left side and right side on FIG. 1) and by the overall width W from a first widthwise end 42 to a second widthwise end 43 (shown as top side and bottom side, respectively, in FIG. 1). As one of ordinary skill will understand, the direction that the strips 22 are laid is inconsequential as far as the performance of the field and is thus not meant to be limited to the directions described herein. As seen in FIG. 1, however, the strips 22 are preferably laid in a regular pattern such that the seams 49 between strips 22 laid from a first lengthwise end 44 to a second lengthwise side are staggered with respect to the next adjacent row 22.

For outdoor playing surfaces, the playing surface 20 is preferably coupled to a polywood fastener 25 along each respective end 42, 43, 44, 45, that is preferably affixed to a concrete curb 27 and prevents shifting of the playing surface 20 during use. For indoor fields, the polywood fastener 25 and concrete curb 27 are generally unnecessary.

The substrate 64 for indoor fields is typically a concrete slab or other firm subsurface. For outdoor fields, the substrate material 64 is a compacted and substantially leveled subgrade, which typically consists of layers of various grades of fine and coarse aggregate material designed to enhance drainage. The shock resistant layer 63 preferably consists of a 1-inch thick layer of rubber or nylon.

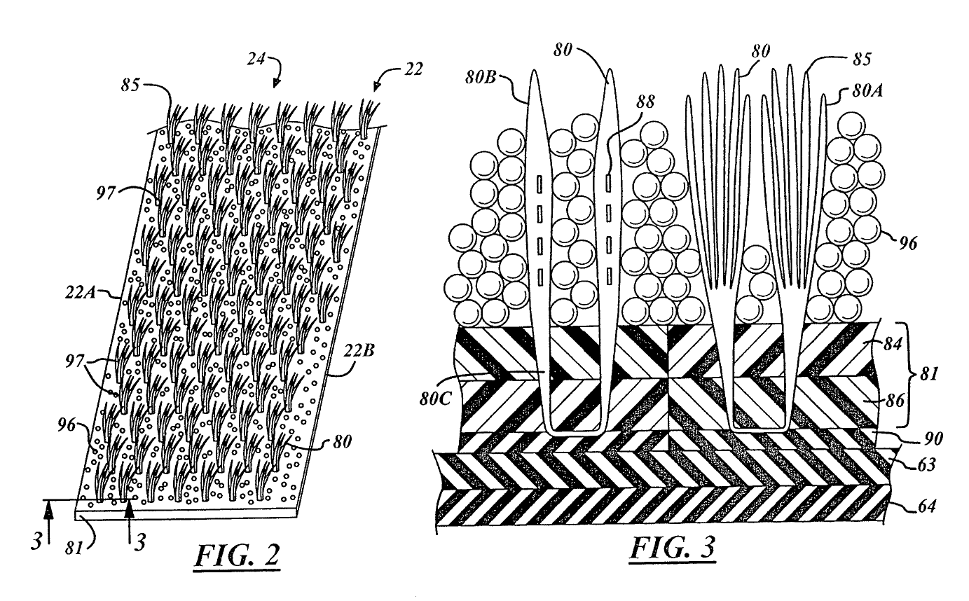

As best shown in FIGS. 2 and 3, the synthetic grass surface 24 has a plurality of synthetic strands 80 tufted (stitched) through a backing layer 81 in rows separated by a first distance, or gauge. The backing layer 81 preferably is formed from one or more layers (here shown as two layers 84, 86) of a backing material. A secondary coating 90 is applied to the bottommost layer 86 to seal the strands 24 to the backing layer 81 and to add a layer of dimensional stability to the backing 81.

A layer of infill 96, preferably consisting of resilient particles, is then disposed interstitially among the strands 80 on top of the backing layer 81 to a depth sufficient to maintain the strands in an upright position. In one embodiment, the depth is less than the overall pile height of the strands 80 extending above the backing layer 81. The infill 96 is composed of a plurality of resilient particles such as cryogenically or ambiently ground rubber. In addition, depending upon the application, sand or other hard granules may be introduced in order to hold down the backing layers 81 facilitate drainage, and reduce cost. Also, other hard particles, such as diatomaceous earth particles, may be introduced to the infill layer to facilitate drainage and possibly act as an insecticide.

The composition of the synthetic strands, as well as the characteristics of the strands (i.e. pile length, denier, stitch rate, stitching pattern), as well as the composition of the backing layer 81 and infill 96, as one of ordinary skill understands, is a matter of design choice and varies depending upon the end use for the playing surface. For the purposes of the inlaying process of the present invention, any one of a number of different commercially available synthetic turf product systems, or turf product systems otherwise described in the prior art, may be utilized herein. One preferred grass surface that may be utilized is described in U.S. patent application Ser. No. 11/144,587 to Cook et al., which is herein incorporated by reference.

The synthetic turf playing surface 20 may have a series of numbers 31, letters 32, logos 34, yard lines 35, sideline markings 37, or other markings 39 (collectively features 29), that are inlaid within or on the surface of one or more strips 22 of the synthetic turf layer 24. The novel process for inlaying these features 29 is described below and shown in FIG. 6.

The strands 80, when applied to the backing material 81, will be preferably configured such that the tufted portion 80C of the strand is aligned in rows (shown as 142 on FIG. 2) and further such that the uppermost ends 85 of the strands lay a particular way on the backing material 81. In other words, the tufting process is performed such that the uppermost ends 85 of the strands 80 will naturally fall substantially in the same direction on top of the backing material 81. The grain (shown as 144 in FIG. 2) of the strip 22 can therefore be classified as “with the grain” or “against the grain”, depending upon an observer's relative position. A “with the grain” positioning is thus defined wherein the uppermost end 85 of the strand 80 has fallen in a direction away from a viewer's eye relative to the tufted portion 80C of the strand, while an “against the grain” positioning is defined wherein the uppermost end 85 of the strand 80 falls towards a viewer's eye. The importance of this grain classification will become evident below.

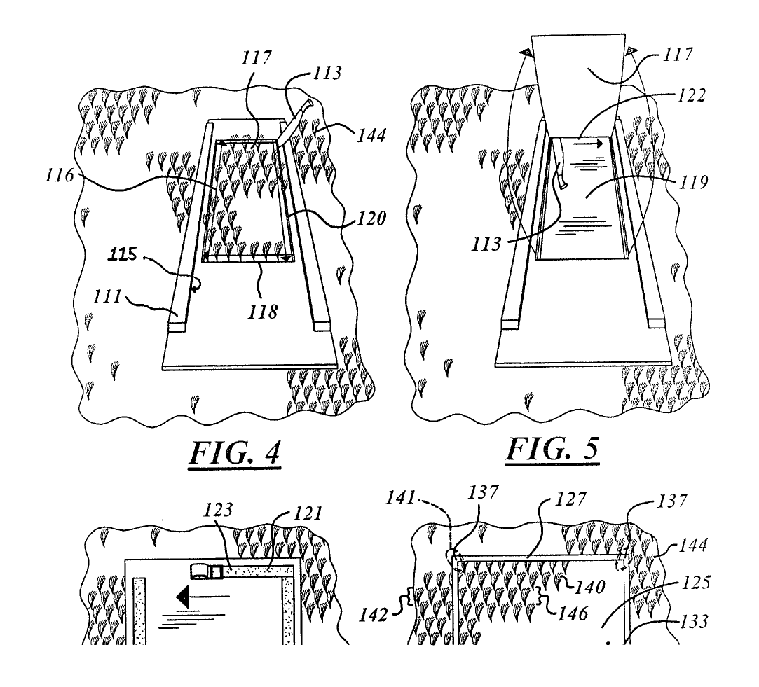

Next, as shown in FIGS. 4-8, numbers, letters, logos, and other markings may be introduced to the field using an inlaying process in accordance with a preferred embodiment of the present invention.

As best shown in FIG. 4, the new process for inlaying the features 29 begins either prior to the introduction of the infill 96 onto the field or after the layer of infill 96 in the immediate area. The infill may be removed by conventional means, including by vacuuming the immediate area of one or more strips 22 of the previously placed field.

The process begins by first introducing a rectangular shaped template 111 onto one or more strips 22 of the previously placed field at a position determined by laser plotting or some other kind of alignment technique, as will be understood by one of ordinary skill. A cutting utensil 113 is used to cut through the backing layers 81 corresponding to the inside edges 115 of the template 111 along three sides 116, 118, 120 of the backing layer 81 of one or more of the strips 22.

Next, as shown in FIG. 5, the cut sides 116, 118, 120 are then rolled upward, wherein the fourth side 122 is cut using the cutting utensil 113 from the backside of the backing material 81. The cut out portion 117 of the strip or strips is removed, leaving an opening 119.

As shown in FIG. 6, a layer of seam tape 121 is introduced to the underlying surface within the opening 119. An adhesive 123 is then applied to the top surface of the seam tape 121.

In alternative preferred arrangements, the seam tape 121 and adhesive 123 are introduced at the same time using a single dispensing device consisting of a tape dispenser and an adhesive tank. The device applies a layer of adhesive material 123 to a top portion of a predetermined thickness onto the seam tape 121 as the seam tape 121 is unrolled from a roller dispenser.

One preferred adhesive 123 is Nordot 346, which is available from Synthetic Surfaces of Scotch Plains, N.J. One preferred seam tape 121 is LPX seaming tape, commercially available from Envirostik Limited of Stafford, United Kingdom. The LPX seaming tape 121 consists of a heavy gauge geo textile fabric laminated to a strong polypropylene mesh film.

As best shown in FIG. 7, a new section 125 of the synthetic grass material, having the features as desired, corresponding in size to the cut out portion 117 is then laid onto the adhesive 123 within the opening 119. The new section 125 of turf is introduced such that the grain 140 and the rows 146 of tufting of the new section 125 substantially match the grain 144 and rows 142 of tufting of the previously placed turf strips 22. The new section 125 of turf is sized slightly smaller than the size of the opening 119, therein forming a gap 127 between it and the previously placed turf 22 along its outer periphery 129. This gap 127 allows the field to contract or expand as a result of weather conditions without bulging or causing deformities in the synthetic turf surface.

A roller 131 is introduced over the new section 125 of turf to cause a portion of the adhesive material 123 to infiltrate the pores 133 along the bottom of the backing material 81 prior to complete cure of the adhesive material 123. The process is preferably repeated after approximately four hours to ensure that the adhesive material 123 has sufficient infiltration to allow the seam tape 121 to be substantially bound to the backing material 81.

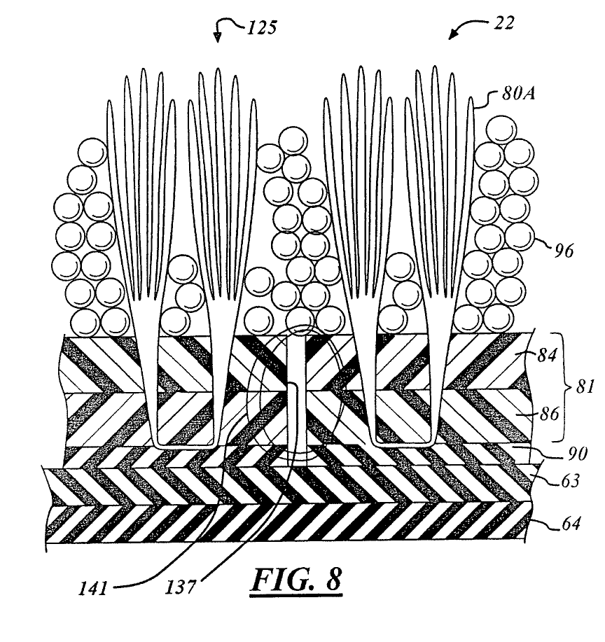

Finally, as best shown in FIGS. 7 and 8, each of the four corners 137 of the new section 125 of turf is stitched to the respective inner edges 139 of previously placed turf 22 using nylon thread 141 or a similar material to ensure that the corners 137 don't peel upwardly during play. In alternative arrangements, the corners 137 may be stitched prior to introducing the rollers 131 to the inlayed new section 125.

After the new section 125 is introduced, the layer of infill 96 is introduced over either the new section 125 or over the entire field to the desired depth by conventional methods.

The present invention provides an improved method for easily integrating features into a sport turf playing field via an inlaying process. The features introduced through the new section of turf have the overall aesthetic appearance required. Moreover, the method provides a new section of turf that minimizes repair times associated with the new section peeling upward during play or bulging outward as the field expands or contracts during various weather conditions.

While the present invention is directed towards inlaying a feature in a field, substantially the same process would be performed to replace a section of field for whatever the reason. For example, the same process described above could be utilized to replace a damaged section of field. Moreover, the present invention could also be utilized to temporarily place and remove a feature in a field. For example, a sponsorship logo could be removed from a field and replaced by a different sponsorship logo, or the hash marks on a football field could be moved to comply with the applicable rules for intercollegiate or professional football.

While the invention has been described in terms of preferred embodiments, it will be understood, of course, that the invention is not limited thereto since modifications may be made by those skilled in the art, particularly in light of the foregoing teachings.

What is claimed is:

1. A method for inlaying a feature in a previously placed synthetic turf field having a plurality of strips of synthetic turf placed onto a substrate, each of the strips of synthetic turf including a plurality of synthetic strands tufted through a backing layer having a top side and a bottom side, the method comprising:
forming a removable rectangular section within at least one of the plurality of strips by cutting a first side, a second side, a third side and a fourth side of said backing layer;
removing said removable rectangular section, therein leaving an opening within said at least one strip extending to the substrate;
introducing a layer of seam tape onto the substrate within said opening;
introducing a layer of adhesive on a top surface of said seam tape;
introducing a new section of said synthetic grass material having a backing material within said opening, said new section of said synthetic grass material sized slightly smaller than said removed rectangular section, said new section including the feature, said new section separated from an inner edge of said at least one strip by a small gap;
introducing a roller onto said new section of said synthetic grass material to cause said adhesive to infiltrate the back side of the backing layer of said new section; and
stitching a thread through each corner of said new section of said synthetic grass material and a corresponding inner edge of said at least one of said plurality of strips.

2. The method of claim 1 further comprising reintroducing said roller onto said new section of said synthetic turf after a predetermined period of time to further cause said adhesive material to infiltrate the backing layer of said new section, said predetermined period of time being not less than about four hours.

3. The method of claim 1, wherein cutting a substantially rectangular section of said at least one strip comprises:
aligning a stencil onto at least one of the plurality of strips; and
cutting a first side, a second side and a third side of a portion of said at least one strip within said stencil.

4. The method of claim 1, further comprising aligning a grain pattern of the plurality of synthetic strands of said new section to match a grain pattern of said at least one strip of the plurality of strips.

5. The method of claim 1, further comprising aligning a grain pattern and rows of the plurality of synthetic strands of said new section to match a grain pattern and rows of said at least one strip of the plurality of strips.

6. The method of claim 1, further comprising aligning the rows of the plurality of synthetic strands of said new section to match the rows of said at least one strip of the plurality of strips.

7. The method of claim 1, wherein the step of stitching a thread through each corner of said new section occurs prior to the step of introducing a roller onto said new section.

8. The method of claim 1, wherein the step of stitching a thread through each corner of said new section occurs after the step of introducing a roller onto said new section.

9. The method of claim 1 further comprising introducing a layer of infill over said new section.

10. The method of claim 1, wherein forming a removable rectangular section comprises:
cutting a first side, a second side and a third side of a portion of at least one of the plurality of strips along the top side of said backing layer opposite the substrate,
folding up said portion of said at least one of said plurality of strips to expose a back side of said backing layer and a portion of the substrate;
cutting a fourth side of said backing layer along the bottom side of said backing layer, therein forming a removable rectangular section;

11. A synthetic turf field having an inlaid feature formed according to the method of claim 1.

12. A synthetic turf field comprising:
a substrate;
a plurality of strips of synthetic turf laid onto said substrate, each of said plurality of strips including a plurality of synthetic strands tufted through a backing layer having a top side and a bottom side;
a rectangular opening contained within at least one of said plurality of strips;
a layer of seam tape coupled to said substrate within said rectangular opening;
a layer of adhesive applied to said layer of seam tape;
a new section of synthetic turf coupled onto said layer of adhesive within said rectangular opening, said new section of turf comprising a feature, said new section of synthetic turf including a plurality of synthetic strands tufted through a backing layer having a top side and a bottom side and having four corners, said new section of turf sized slightly smaller than said rectangular opening, therein defining a small gap between said new section of turf and said at least one of said plurality of strips,
a thread stitched through one of said four corners and a corresponding portion of said at least one of said plurality of strips across said small gap; and
a layer of infill coupled onto said plurality of strips and said new section.

13. The synthetic turf field of claim 12, wherein said feature is selected from the group consisting of a series of numbers, letters, logos, yard lines, sideline markings, and other markings.

14. The synthetic turf of claim 12, wherein a grain pattern of said plurality of synthetic strands of said new section substantially matches a grain pattern of said plurality of strands of said at least one strip of said plurality of strips.

15. The synthetic turf of claim 12, wherein a grain pattern of said plurality of synthetic strands of said new section substantially matches a grain pattern of said plurality of strands of said at least one strip of said plurality of strips; and
wherein a row pattern of said plurality of synthetic strands of said new section substantially matches a row pattern of said plurality of strands of said at least one strip of said plurality of strips.

16. The synthetic turf of claim 12, wherein a row pattern of said plurality of synthetic strands of said new section substantially matches a row pattern of said plurality of strands of said at least one strip of said plurality of strips.
